(19) United States
(12) Patent Application Publication
(10) Pub. No.: US 2012/0035836 A1
(43) Pub. Date: Feb. 9, 2012

(54) ONBOARD NETWORK FOR A VEHICLE HAVING A START-STOP SYSTEM

(76) Inventors: Wolfgang Mueller, Stuttgart (DE); Guenter Reitemann, Schwieberdingen (DE); Michael Merkle, Stuttgart (DE); Marcus Abele, Schwieberdingen (DE)

(21) Appl. No.: 13/138,101

(22) PCT Filed: Nov. 10, 2009
(86) PCT No.: PCT/EP2009/064866

§ 371 Date: Sep. 23, 2011

(30) Foreign Application Priority Data
Jan. 7, 2009 (DE) 10 2009 000 046.1

(51) Int. Cl. F02D 28/00

(52) U.S. Cl. 701/113

(57) ABSTRACT

An onboard network for a vehicle having a start-stop system includes a central module having a control unit SG and switch elements, the central module including terminals port A, port B, port C, port D, port E, and port F for the connection of further components of the onboard network. A generator of the onboard network is connected to a first terminal port A, a starter is connected to a second terminal port B, at least one energy storage is connected to a third terminal port C, a further energy storage is connected to a fourth terminal port D, and electrical consumers of the onboard network are connected to the fifth terminal port E.

### BACKGROUND OF THE INVENTION

1. Field of the Invention

The present invention relates to an onboard network for a vehicle having a start-stop system, and a method for controlling such an onboard network.

2. Description of Related Art

Novel technical approaches have increasingly been developed and put into mass production to reduce the fuel consumption and to decrease the emissions of a motor vehicle. One technical approach is a so-called start-stop system. In such a system, the engine of the vehicle is always temporarily shut down under specific conditions if the vehicle is temporarily stationary, for example, at a red light or in a traffic jam. A further technical approach for reducing the fuel consumption is the recuperation of electrical energy during the coasting and braking phases of a vehicle. In this case, for example, the generator voltage is increased during the coasting and braking phases, whereby the generator outputs increased power to the onboard network, which may then be stored in an energy storage of the vehicle.

There are also already approaches, in which additional electrical energy is obtained using a still higher voltage during the recuperation phase. For this purpose, for example, a generator having a variable output voltage, which is known, for example, from published German patent application document DE 10 2004 043 129 A1, may be used. In such systems, capacitors are frequently primarily used as charge storages. Overall, these technical innovations also result in new demands and requirements regarding the electrical onboard network, which will be described briefly hereafter.

A high power and therefore a high current are required when starting an internal combustion engine, in particular in winter at low temperatures. Depending on the power of the internal combustion engine of the vehicle, the required peak current may be several hundred amperes up to approximately 1000 A. This high current has heretofore been provided by the battery of the onboard network. However, this system configuration has the following disadvantages, which are to be observed both in the case of modern start-stop systems and also in typical starting systems. As a result of the high peak current when the vehicle is started, a voltage drop occurs in the onboard network of the vehicle, which has a disadvantageous effect on the electrical and electronic components of the onboard network. Thus, for example, those devices which do not themselves contain buffer units for bridging a critical voltage drop, for example, infotainment devices, often at least temporarily fail. Particularly in the case of the relatively frequent start-stop actions of a start-stop system, this results in a significant reduction of the driving comfort.

Furthermore, the battery used in an onboard network is designed for the requirements of an engine start at very low temperatures. However, the battery is therefore over-dimensioned for most operating states occurring in driving practice. Since currently lead-acid batteries are still typically used as standard vehicle batteries, this has disadvantageous effects on the weight of the vehicle. A high vehicle weight in turn has a disadvantageous effect on fuel consumption. In the case of the spatial configuration of the battery in the vehicle, the voltage drop in the connection between the battery and the starter of the vehicle plays a particularly important role. In order to prevent an excessively large voltage drop, this connection line must have the lowest possible electrical resistance. Therefore, it must have a large cross section, which makes it heavy, inflexible, and costly, however. This makes the price for the vehicle more expensive because of the high raw material costs for copper. If the battery is situated in the rear area of the vehicle, but the engine including the starter is situated in the front area of the vehicle for reasons of the space required and for weight optimization, the risk of the occurrence of electromagnetic interference is additionally increased.

In the case of a vehicle equipped with a start-stop system, the more frequent start and stop phases result in higher stress on the battery in comparison to a typical onboard network. This may not be completely compensated for by the design of the onboard network. Therefore, a shorter battery service life must normally be expected in the case of a start-stop system. Conventional lead-acid batteries are only suitable to a very limited extent for the recuperation of electrical energy, for example, during the braking and coasting phases.

In order to be able to at least partially counteract the above-mentioned effects, the obtained electrical energy is buffered in suitable power storage units. The current for starting may be taken therefrom or supplied to other consumers of the onboard network. However, if multiple energy storages in the form of batteries and/or capacitors are provided in the onboard network and if these energy storages may be coupled to one another via switch elements or relays, the risk arises that, in particular in the event of different charge states or different voltage levels, high compensation currents will flow when the energy storages are interconnected. The amperage of a flowing compensation current may be several hundred amperes due to the comparatively low internal resistance of the energy storages. Such a strong current may impair the service life of the energy storages and the switch contacts and represents a risk to the stability of the onboard network.

### BRIEF SUMMARY OF THE INVENTION

The present invention is based on the object of providing an improved onboard network for a vehicle having a start-stop system and a method for the control thereof. The present invention proceeds from the finding that through the use of at least two energy storages, a typical battery, on the one hand, and a capacitor having high capacitance, on the other hand, and the linkage thereof to a voltage converter circuit, which is alternately to be operated as a step-down converter or as a step-up converter, a particularly reliable and dependable onboard network may be provided.

The onboard network provided by the achievement of the object according to the present invention is distinguished in that, through an expedient control of the multiple energy storages provided in the onboard network, a sufficiently large amount of starting energy is always available to be able to perform at least one, preferably multiple, starting procedures, as a function of the engine temperature and/or the ambient temperature. By monitoring and possibly limiting the starter current, a sufficiently long service life of the highly stressed starter may additionally be achieved, in spite of an increased number of starting procedures, in the case of a vehicle equipped with a start-stop system. Through the use of a multi-voltage generator or a generator in combination with a step-up converter, braking energy of the vehicle may be reclaimed particularly efficiently in recuperation operation.

### BRIEF DESCRIPTION OF THE DRAWINGS

FIG. 1 shows a simplified block diagram of an onboard network.

FIG. 2 shows a further exemplary embodiment of an onboard network.

FIG. 3 shows a further exemplary embodiment of an onboard network.

FIG. 4 shows a block diagram of an onboard network to explain a starting procedure.

FIG. 5 shows a block diagram of an onboard network to explain the recuperation operation.

FIG. 6 shows a block diagram of an onboard network to explain a cold start.

FIG. 7 shows a block diagram of an onboard network to explain the charging procedure of an energy storage.

FIG. 8 shows a block diagram having a multichannel embodiment variant.

FIG. 9 shows the voltage curve as a function of time in the case of the multichannel embodiment according to FIG. 8.

### DETAILED DESCRIPTION OF THE INVENTION

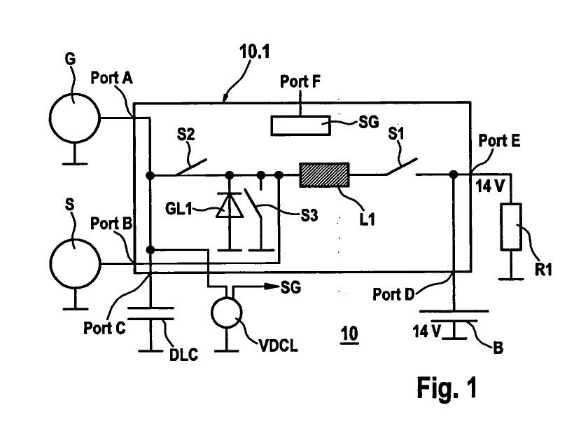

FIG. 1 shows a simplified block diagram of an onboard network 10 for a vehicle having a start-stop system. The essential components of an onboard network 10 for understanding the present invention are shown. Onboard network 10 includes a generator G and a starter S. At least one battery B and at least one capacitor DLC are provided as energy storages for storing an electrical charge. Capacitor DLC is preferably a capacitor having large capacitance, in particular a double-layer capacitor. Resistor R1 represents electrical consumers of the onboard network. As is typical in standard onboard networks, generator G, starter S, battery B, capacitor DLC, and resistor R1 are connected via one of their connection lines to the ground terminal of the onboard network. The free terminal of generator G is connected via port A to the first terminal of a switch element S2 and the free terminal of capacitor DLC, which is applied to port C. The free terminal of starter S is connected via port B to the second terminal of switch element S2 and the first terminal of an inductor L1. The second terminal of inductor L1 is connected to the first terminal of a switch element S1. The free terminal of resistor R1 is applied via port E to the second terminal of switch element S1. The free terminal of battery B is also applied via port D to the second terminal of switch element S1. A rectifier element GL1, preferably a semiconductor diode, is between the first terminal of inductor L1 and ground. Furthermore, a switch element S3 is between the first terminal of inductor L1 and ground. Switch elements S1, S2, S3 are controllable via a control unit SG, whose control signals are supplied via port F. Listed components S1, S2, S3, GL1, and L1 are combined to form a central module 10.1.

Control unit SG is preferably a functional module, which controls the start-stop operation of the vehicle and/or the recuperation operation of the vehicle. Generator G is preferably a so-called multi-voltage generator which, depending on the operating state of the onboard network, may generate output voltages having different voltage levels. In normal operation, generator G may output an output voltage of approximately 14 V, for example, which corresponds to the nominal voltage of onboard network 10. In recuperation operation of the vehicle, generator 10 delivers a higher output voltage, which is between 14 V and 32 V, for example. Through the selection of a higher output voltage, the acquisition of energy by recuperation may be made more efficient, i.e., more braking energy may be recuperated, at an approximately identical overall size of generator G. The recuperation energy obtained via generator G is preferably stored in first energy storage DLC, which is designed for a higher operating voltage than the nominal voltage of onboard network 10.

The components situated in central module 10.1 form a voltage converter circuit. This circuit may advantageously function in a first operating state as a step-up converter and in a second operating state as a step-down converter. During usage as a step-down converter, the higher voltage level of energy storage DLC is converted to the nominal voltage of the onboard network, in order to charge the second energy storage, battery B. During usage as a step-up converter, the nominal voltage of the onboard network is raised to a higher level to be able to charge first energy storage DLC from the second energy storage, battery B, using this higher voltage in particular. In this way, the first energy storage is always sufficiently charged to operate starter S and successfully start the engine of the vehicle. The capacitance of the energy storage is expediently selected so that the energy stored therein is sufficient to allow at least one, but preferably multiple, starting procedures. The modes of operation of the voltage converter circuit are controlled by control unit SG. Onboard network 10 further includes a measuring unit VDCL for the voltage measurement on first energy storage DCL. The measured voltage is preferably analyzed by control unit SG. In further embodiment variants, charge storage B may also be connected to the onboard network outside central module 10.1. In this application, port D is omitted. Furthermore, energy storage DLC may also be connected to generator G outside central module 10.1. In this case, port C is omitted.

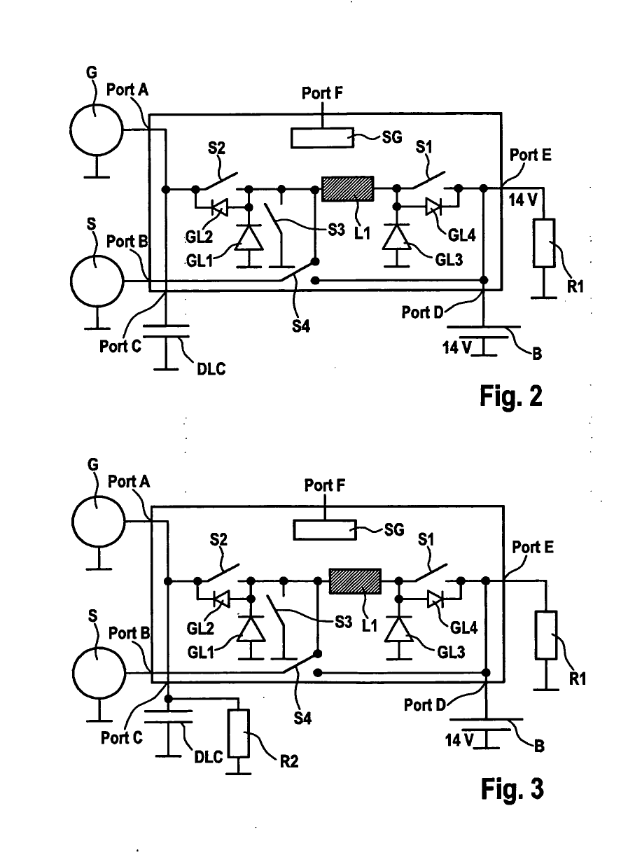

FIG. 2 shows an onboard network 20 having an additional switch element S4. One terminal of switch element S4 is connected to starter S via port B. Switch element S4 may assume two switch positions. In a first switch position, a switch member of the switch element is connected to the first terminal of inductor L1. A connection is thus produced via switch element S4 between the first terminal of inductor L1 and, via port B, the ground-remote terminal of starter S. In a second switch position, a switch member of switch element S4 is connected via port D to battery B. In this switch position, there is therefore an electrical connection between the ground-remote terminal of starter S and battery B. Furthermore, onboard network 20 shown in FIG. 2 includes a rectifier element GL3 connected between the second terminal of inductor L1 and ground. Finally, onboard network 20 further includes rectifier elements GL2, GL4, which are connected parallel to switch element S2 and switch element S1, respectively.

FIG. 3 shows a further embodiment variant, in which resistor R2, which represents an electrical consumer of the onboard network, is connected to port C and may take energy from capacitor DLC in this way.

In contrast to a conventional vehicle, a modern vehicle which is equipped with a start-stop system must be started significantly more frequently. For reasons of saving energy and protecting the environment, the drive engine of such a vehicle is to be shut down during every stop and reliably started again thereafter. In order to allow this dependably and permanently, an elaborate control of the onboard network is necessary. In order to ensure that the energy stored in energy storage DLC is sufficient for a reliable restart of the drive engine, a threshold value THRESHOLDC for the voltage at energy storage DLC is preferably predefined according to the present invention. A starting procedure of starter S by supplying energy from energy storage DLC is only permitted if the voltage measured at energy storage DLC exceeds threshold value THRESHOLDC. Threshold value THRESHOLDC may advantageously be made changeable, in order to take the temperature of the engine and/or the ambient temperature into consideration, for example. It may thus be ensured, for example, that in the case of a cold start, more energy is available than in the case of a hot start. If an excessively low voltage is established at energy storage DLC, which is primarily intended for supplying energy to starter S, it may be recharged by supplying energy from the second energy storage (battery B). The charging of energy storage DLC is made possible in that the nominal voltage of the onboard network, typically of approximately 14 V, is raised by a step-up conversion using a voltage converter in central module 10.1 to a higher value, for example, approximately 32 V. If it is established by voltage measurement during a starting procedure with starter S being supplied with energy from energy storage DLC that the voltage at the energy storage has dropped to the level of the nominal voltage of the onboard network, energy storage DLC may advantageously be connected to the energy storage, battery B, in order to provide sufficient starting energy for starter S. The control of the diverse switching elements required for this purpose is performed by control unit SG.

In order to achieve the longest possible service life of the starter in spite of the frequent starting procedures, a power limit for the starter current is provided according to the present invention, in order not to overload starter S. A power limit is advantageously achieved by a two-point regulation. For this purpose, switch element S2 is correspondingly clock-controlled by control unit SG. Semiconductor switch elements are preferably used as switch elements in the onboard network designed according to the present invention. A measuring unit for detecting the amperage may preferably be integrated therein. This may be a measuring resistor having a low resistance value, for example, at which a voltage drop corresponding to the amperage occurs when current flows through, the voltage drop being comparatively easily detectable by a measuring unit.

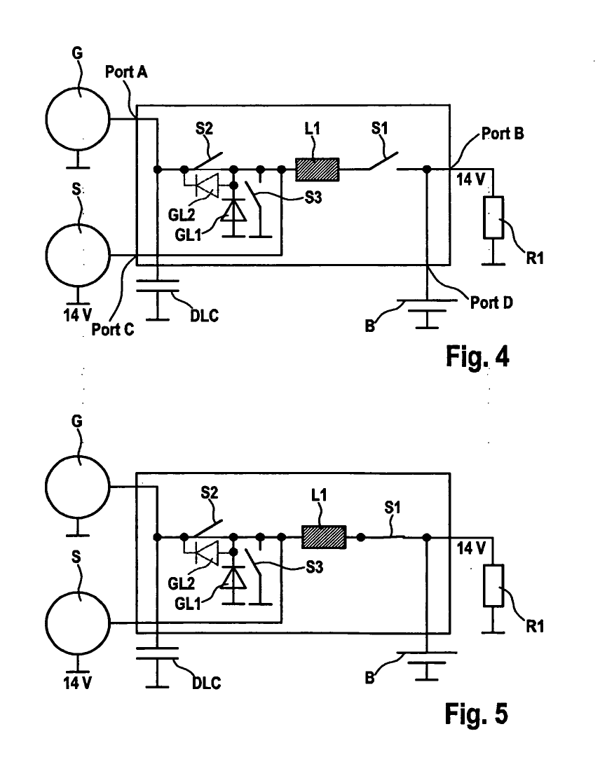

Different operating states of the vehicle are explained hereafter with reference to FIG. 4 through FIG. 7, which also each show simplified views of the onboard network of a vehicle having a start-stop device.

A hot start using energy supply from energy storage DLC is explained hereafter on the basis of FIG. 4. Generator G is inactive during the start. Switch element S2 is clock-controlled in order to supply starter S with current from energy storage DLC. Switch element S3 may be used as a freewheeling diode. Alternatively, diode GL1 may assume the freewheeling function. Switch element S1 is opened during the starting procedure.

Recuperation operation and normal operation will be explained briefly with reference to FIG. 5. During recuperation operation, switch element S2 is closed. Generator G is set to a higher output voltage. The output voltage of generator G is applied to energy storage DLC and charges it. Switch element S2 is clock-controlled in order to step down the high voltage output by generator G to a lower voltage level, via which energy storage B may be charged to a voltage of approximately 14 V, for example. In normal operation, switch element S1 is closed. Switch element S2 is also closed. Energy storage DLC may thus also buffer the onboard network (consumer R1) supplied with energy by energy storage B.

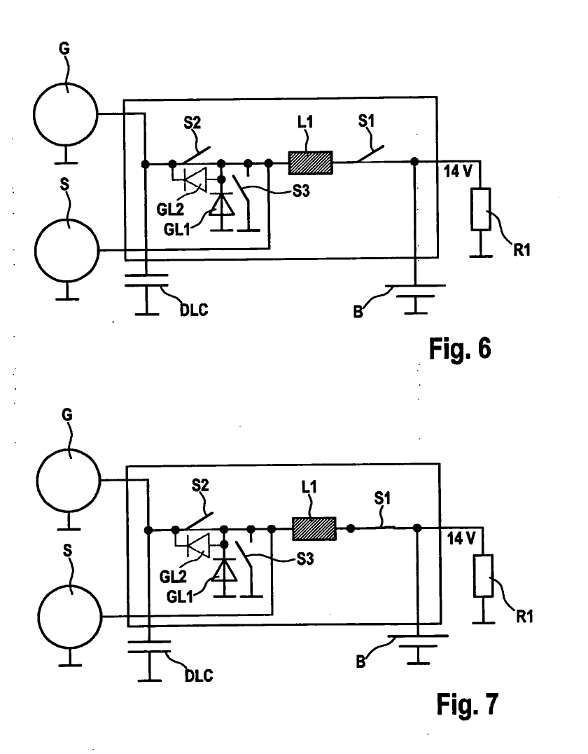

A so-called cold start will be explained with reference to FIG. 6. When energy storage DLC is charged, switch element S2 is controlled in such a way that the starting current for starter S may first be taken from energy storage DLC. If the voltage at energy storage DLC drops below the voltage of energy storage B, the switch element may be closed so that starter S is additionally supplied with energy from energy storage B. Generator G is inactive during the starting procedure.

The charging of energy storage DLC will be described hereafter with reference to FIG. 7. After the closing of switch element S1, energy storage DLC may be charged to its setpoint voltage of approximately 14 V from the onboard network including energy storage B. In contrast, if energy storage DLC is to be charged to a higher voltage, a step-up conversion must be performed. For this purpose, switch element S3 is clock-controlled. Switch element S2 may be controlled in terms of synchronous rectification. If a MOSFET transistor is used for switch element S2 in an embodiment variant, its substrate diode may also be used for the rectification.

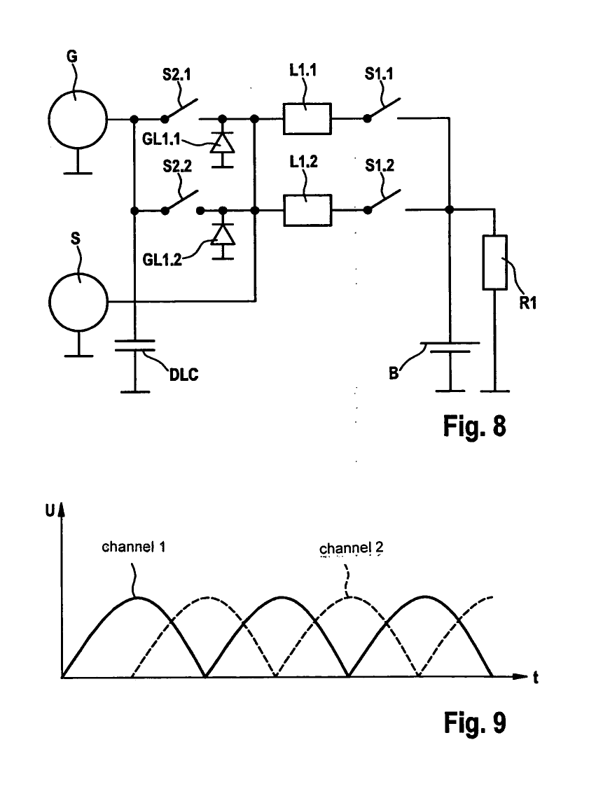

In a particularly advantageous embodiment variant (FIG. 8), the circuit configuration has a multi-channel design. The illustrated example shows a two-channel design. In the first channel, a switch element S2.1, a rectifier element GL1.1, an inductor L1.1, and a switch element S1.1 are situated between generator G and energy storage B. In the second channel, a switch element S2.2, a rectifier element GL1.2, an inductor L1.2, and a switch element S1.2 are situated between generator G and energy storage B. The listed switch elements are in turn controllable by a control unit SG (not shown in FIG. 8). As shown by the voltage curve in FIG. 9, the waviness of the voltage or current curve may advantageously be reduced by a multichannel embodiment and a time-offset clock control. FIG. 9 shows an example of the curve of charge voltage U as a function of time t at energy storage B.

1-20. (canceled)

21. An onboard network for a vehicle having a start-stop system, comprising:
a generator;
a starter;
at least one energy storage; and
a central module having a control unit, multiple switch elements controllable by the control unit, and multiple terminals for connecting the central module to other components of the onboard network.

22. The onboard network as recited in claim 21, wherein the generator is connected to a first terminal, the starter is connected to a second terminal, the at least one energy storage is connected to a third terminal, a further energy storage is connected to a fourth terminal, and electrical consumers of the onboard network are connected to a fifth terminal.

23. The onboard network as recited in claim 22, further comprising:
a voltage converter circuit situated between i) a first set of terminals including the first and third terminals and ii) a second set of terminals including the fourth and fifth terminals.

24. The onboard network as recited in claim 23, wherein the voltage converter circuit is switchable as a step-up converter.

25. The onboard network as recited in claim 23, wherein the voltage converter circuit is switchable as a step-down converter.

26. The onboard network as recited in claim 22, wherein the at least one energy storage is configured to store sufficient energy to enable multiple starting procedures of the starter.

27. The onboard network as recited in claim 22, further comprising:
a measuring unit configured to provide a voltage measurement at the at least one energy storage.

28. The onboard network as recited in claim 22, wherein switch elements include semiconductor switch elements each having an integrated current measuring unit.

29. The onboard network as recited in claim 22, wherein the control unit is a functional module configured to control at lest one of a start-stop operation and a recuperation operation of the vehicle.

30. The onboard network as recited in claim 22, wherein the onboard network has a multi-channel design.

31. A method for controlling an onboard network for a vehicle having a start-stop system, the onboard network having a generator; a starter; at least one energy storage; and a central module having a control unit, multiple switch elements controllable by the control unit, and multiple terminals for connecting the central module to other components of the onboard network, the method comprising:
predefining a threshold value for the voltage at the at least one energy storage; and
measuring the voltage at the at least one energy storage;
enabling a starting procedure of the starter by supplying energy from the at least one energy storage only if the measured voltage at the at least one energy storage exceeds the predefined threshold value.

32. The method as recited in claim 31, wherein the threshold value is established as a function of at least one of an ambient temperature and an engine temperature.

33. The method as recited in claim 32, wherein the at least one energy storage is charged by the onboard network if the measured voltage at the at least one energy storage falls below the threshold value.

34. The method as recited in claim 32, wherein the voltage at the at least one energy storage is measured during a starting procedure of the starter using energy supplied from the at least one energy storage, and if the measured voltage at the at least one energy storage equals or falls below the value of the onboard network voltage, a further energy storage element is connected to the at least one energy storage by controlling at least one switch element.

35. The method as recited in claim 32, wherein the voltage at the at least one energy storage is measured before initiating a starting procedure of the starter, and if the measured voltage value at the energy storage falls below the threshold value, a switch element is closed to connect the starter to a further energy storage element which supplies energy required for the starting procedure.

36. The method as recited in claim 32, wherein the voltage at the at least one energy storage is measured before initiating a starting procedure of the starter, and at least a startup current of the starter is supplied by the at least one energy storage if the measured voltage at the at least one energy storage is higher than a voltage at a further energy storage element, and the further energy storage element is connected to the started if the voltage at the at least one energy storage equals the voltage of the further energy storage.

37. The method as recited in claim 32, wherein a current through the starter during a starting procedure of the starter is limited to a predefined limiting value.

38. The method as recited in claim 37, wherein the limiting of the current through the starter is implemented by a two-point regulation.

39. The method as recited in claim 37, wherein the limiting of the current through the starter is implemented by a clock control of one of the switch elements.

40. The method as recited in claim 32, wherein the switch elements are controlled in such a way that a further energy storage element is charged by the generator using a nominal voltage of the onboard network, and wherein, in recuperation operation, the at least one energy storage is charged using a voltage greater than the nominal voltage of the onboard network.
